(19) United States
(12) Patent Application Publication
(10) Pub. No.: US 2009/0197235 A1
(43) Pub. Date: Aug. 6, 2009

(54) Instruction System and Method

(76) Inventors: Peter J. Tormey, Concord, CA (US); Patrick M. Tormey, Derry, NH (US)

Correspondence Address: PETER JAMES TORMEY, 2017 ESPERANZA DRIVE, CONCORD, CA, 94519, US

(21) Appl. No.: 12/362,164

(22) Filed: Jan. 29, 2009

Related U.S. Application Data
(60) Provisional application No. 61/025,292, filed on Jan. 31, 2008.

(51) Int. Cl. G09B 7/00

(52) U.S. Cl. 434/350; 434/362

(57) ABSTRACT

A system and method for computer-aided learning that provides for selecting question information from a structured data source and presenting a question to a networked user at irregular or otherwise predetermined time intervals. Described also is measuring the length of time required for the user to respond to the question before presenting the user additional question information to the user, providing user generated text information associated with the question and presenting links to an online community associated with the question.

### CROSS REFERENCE TO RELATED APPLICATION

This application claims the benefit of provisional patent application 61/025,292 filed Jan. 31, 2008.

### BACKGROUND

The present invention relates generally to computer aided instruction, and more particularly to a system and method for electronic testing a person's knowledge over an extended period of time.

There are many fields that require professional examinations before a person is allowed to practice in the industry. Examples include law, engineering, accounting and medicine. These professional examinations are often given after years of study and assess the examinee's accumulated knowledge of the subject matter. For students learning these various arts, the task of preparing for an exam is arduous because they may have had to learn a wide variety of differing subjects over an extended period of time. The result, for most examinees, is that they must have a period of “cram time” wherein they systematically review all they have learned.

To lessen the emotional, economic and physical effects of intense cramming for exams, students often divide the subject matters into manageable portions such that each topic may be more easily addressed. Study sessions usually involve periods of intense studying a single subject and these sessions distract from other activities such as work. For a student, the simple process of sitting down at a desk and working on problems can be a hindrance because it is separate time detached from regular daily activities. A more beneficial learning scheme would be if studying was incorporated into the day-to-day activities of the student. This would alleviate the distraction aspect of studying, yet still engage the student in regular consistent learning activities. As such, what is needed is a learning system wherein the student is engaged in the learning process as part of their day-to-day activities.

### SUMMARY OF THE DISCLOSURE

Disclosed herein is a system and method for computer aided learning. The disclosure provides for an interactive training system having short pieces of information spread out over an extended period of time, such as a workday. This may allow for students to stay continually challenged by a series of questions, but without committing to a set study period each day. For example, a student may be periodically questioned at irregular intervals while at work without the need to stop work for an extended period of time to answer the questions.

The inventors have found that timed-response questions presented throughout the day instead of during a single study session force a student to learn so that they have a “top-of-mind” awareness of the material under consideration. This improves overall recall and prepares for standardized test taking by adding timing and subject matter variations to the learning environment. Instead of cramming for one subject at one time, students are forced to respond throughout an extended period under timed conditions.

The disclosure provides for selecting question information from a structured data source and presenting a question to a networked user at irregular or otherwise predetermined time intervals. Described also is measuring the length of time required for the user to respond to the question before presenting additional question information to the user. The disclosure also provides for user generated text information associated with the question to be optionally available and presenting links to an online community associated with the question.

The disclosure provides for further customization to meet specific testing or educational requirements regarding differing subject matter and student grouping.

### BRIEF DESCRIPTION OF THE DRAWINGS

FIG. 1 illustrates one embodiment of an instruction system.

FIG. 2 illustrates a flowchart of a method for one embodiment of an instruction system.

FIG. 3 shows one embodiment of a user interface for an instruction system.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### DEFINITIONS

The phrase “question information” and the like, generally refers to a question, answer or information pertaining to the question. Question information may include inter alia, a question, a correct answer or explanation on why certain answers are incorrect.

The phrase “explanatory text” generally refers to words that describe or explain a question and provide educational material about a question.

The phrase “structured file” or “structured data file” generally refers to information stored electronically in a database or other machine or human readable format such as comma delimited text or extensive markup language (XML) and the like.

### System Elements

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

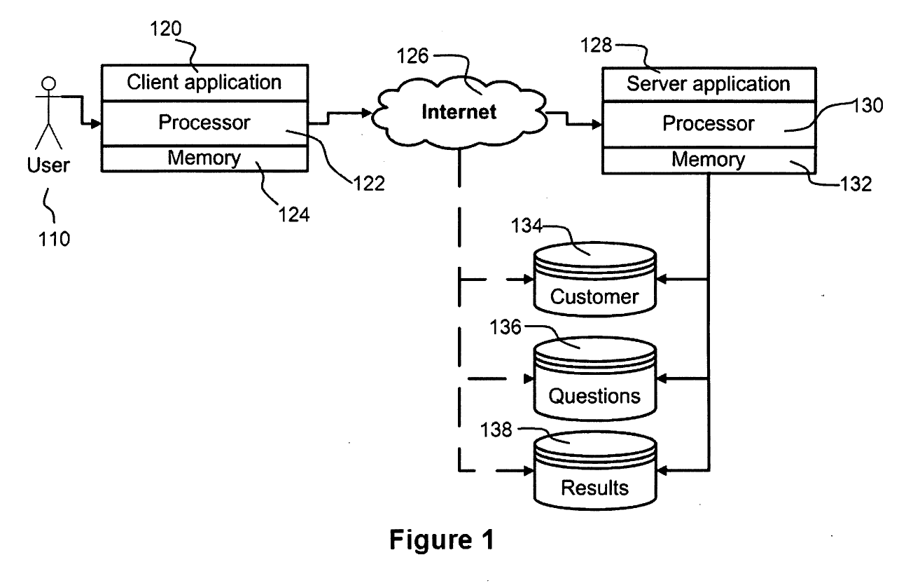

FIG. 1 shows a functional diagram of one aspect of an instruction system. In the FIG. 1 a user 110 interacts with a client 120. The client 120 contains a processor 122 and one or more memory circuits 124 for presenting an interface to the user 110. The client application communicates through a network 126, such as the Internet, to a server application 128. The client application 120 provides for receiving a question from the server application. The question may be in the form of multiple choice, short answer or other form to allow for the user 110 to answer the question relatively more quickly than essay-type questions. The client application 120 notifies the user 110 that a question has been received, then upon the user's 110 selection allows the user 110 to view the question. The client application records the time between viewing the question and when the user 100 answers the question. Upon answering the question, the client 120 transmits the answer to the server application 128 and displays the correct answer to the user 100. The user thus receives immediate feedback on the correct answer.

The server 128 contains a processor 130 and one or more memory circuits 132. The client is further connected to a network 126 such as the Internet, and is coupled to one or more databases. These databases provided for structured information such as a customer database 134 for storing information about the customer and customer preferences, a question database 136 for storing question and answer information and a results database 138 for storing result information. The server 128 may connect to the databases directly or couple to them through a network 126.

The processor 130 and memory circuits 132 operating with the databases may also store information entered by users 110 and provide for coupling the information entered by users 110 to questions and answers. Further, the processor may present the information to users 110 in the form of message boards, user's groups, instant messaging, discussion boards and other network community involvement techniques. In addition, the questions may be selected by a user and presented to specific groups of other users thus allowing for parallel operation among many different groups.

### System Operation

In operation the server 128 selects a single question from the question database 136 according to information stored in the customer database 134. The server 128 transmits the question information to the client 120 wherein the client 120 notifies the user 110. Upon recognizing the notification, the user 100 instructs the client to present the question, wherein the client 120 presents the question to the user 110. Once the user has entered an answer, the client 120 transmits the answer to the server 128 wherein the server records the answer in the results database 138. The client 120 may also allow for a user to enter notes or other information in addition to the response, and these would be transmitted to the results database 138. The client 120 further transmits to the server 128 the time between presenting the question to the user 100 and when the user 110 entered the answer. Finally the user 110 is presented with results information. Results information includes the correct answer and may include information or instructions about the incorrect answers or other instructional material.

Operationally, the answer and results information may be transmitted along with the question and displayed for the user 110 upon the user answering the question. Alternatively, the results information may be sent from the server to the client in response the server receiving an answer to a question. In addition, the client 120 may be a program electronically coupled with the server 128 wherein the client provides an alert indication such as a visible or audible indication when a question is received. This may be effectuated with a resident application on a processor-base device such as a personal computer, personal data assistant (PDA), cell phone or other device allowing for electronic communication over a network. The client may also be accomplished though other applications such as calendaring, email, weather monitoring, instant messaging and similar applications.

The server operation may use a randomizer to select a question to send to a user. The question may be based on information in the customer database, the results database or a combination of the two. This allows for the server to resend a question that a user that had previously answered incorrectly. It also allows for the server to select and transmit questions having certain proportions of prior incorrect responses such that the instruction system can provide more questions in areas where a user has exhibited a tendency to answer incorrectly. Further, the notes function provides for reporting that includes notes so that the note may be used as study aids for a user. In an embodiment a user may be able to see the notes information before answering the question.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

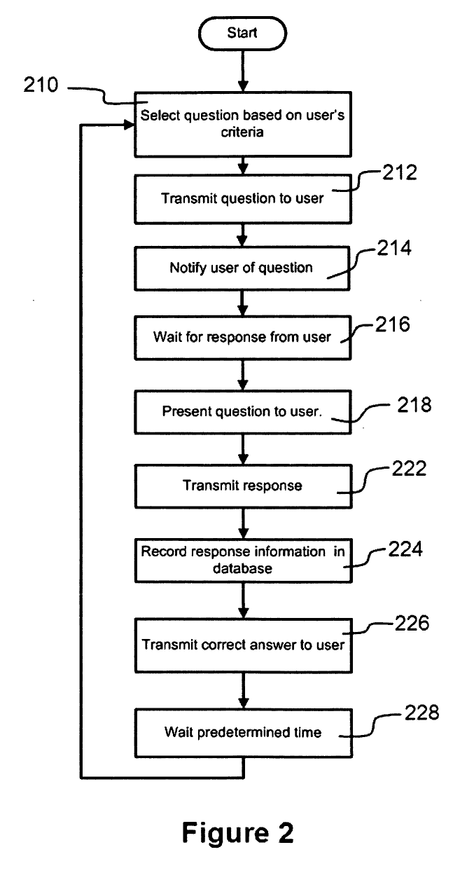

FIG. 2 illustrates a flowchart of an aspect of one embodiment of an instruction system. In the FIG. 2 a question is selected based on information about a user 210, for example topic, timing and contact information. The question is transmitted to the user 212, and the user is notified of the question 214. After notifying the user, a waiting period begins 216 for the user to respond to the question. Once the user responds, the question is presented to the user 218. The user, having been notified and presented with the question, responds 220 and the user's response, in the form of an answer, is transmitted 222. The user's response is further recorded as structured data in, for example, a database 224 or other structured recording means. If the correct answer and information regarding the incorrect answers was not already transmitted to the user, the correct answer along with any associated training information is transmitted to the user 226. Since the learning process is a continual process of sending questions and training material, the system waits for a predetermined time 228 before repeating the process. The wait time may be part of the information about a user derived from step 210.

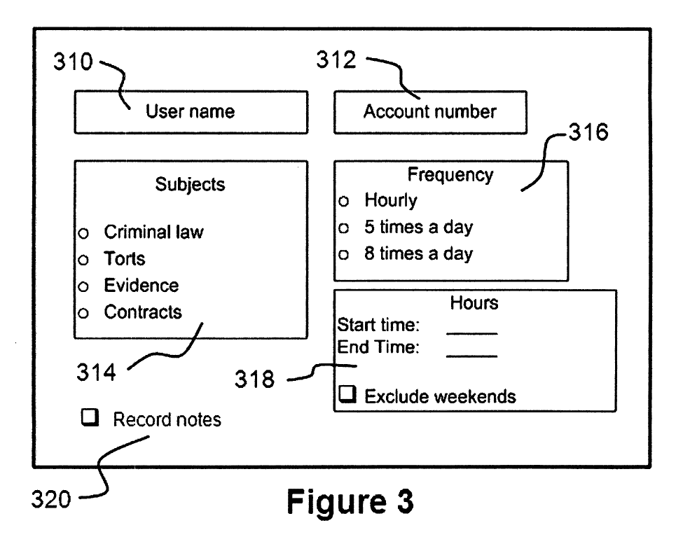

FIG. 3 shows a potential user interface for an instruction system. In the FIG. 3, a portion of the interface identifies a user 310, and user contact information 312. Another portion of the user interface identifies instructional topics 314 whereas yet another portion of a user interface identifies frequency 316 and hours 318 of providing questions and instructional material. The FIG. 3 also illustrates the usefulness of the disclosed instruction system. The system provides for an interactive training system of short pieces of information spread out over an extended period of time, such as a workday. This may allow for students to stay continually challenged by a series of questions, but without committing to a set study period each day. For example, a student may be periodically questioned at irregular intervals while at work without the need to stop work for an extended period of time to answer the questions. Alternatively the questions could be presented randomly to a similar affect.

The user interface of FIG. 3 provides information to a customer database thus providing to an application the information required to select topics of educational purposes and indicating when those topics or questions should be presented to a user. The information illustrated in FIG. 3 may be readily stored in a structured data entity, and further, that a structured entity of questions could be queried and a question selected and transmitted based on this information. Further, an application directed towards a user could be effectuated using conventional programming languages, tools and techniques including database tools, hypertext markup language and popular programming languages.

FIG. 3 also illustrates a note taking feature of the instruction system. A user may add notes 320 or other comments to a particular question for retrieval in a database. This allows for the user to record information about the particular question of interest for later study. The note may be attached as part of the answer when transmitting to a server, or alternatively, added after receiving the correct answer. Reports containing the notes may be generated as a study aid for the users. Additionally, users may flag certain questions such that they are repeated based on the note, in response to an entry in the note information, or other criteria such as answering the question incorrectly. This allows for a user to “drill” themselves by repeating questions. For example, if the user answers a certain number of questions incorrectly, they can instruct the system to repeat those questions more often. Also, a user may have access to the notes information before answering the question.

Another aspect would include links to a networked electronic discussion board (or discussion group) covering answers to a question. By way of example, each question would also be presented with a link to a network based discussion board. The discussion board would allow for various users to discuss issues concerning a particular question. The discussion board may provide features such as searching, links to similar questions or more information about a topic. Over time, the discussion board would become a resource for future students using the system.

Reports may be generated from the results data showing how well the user is performing in the differing areas. This will allow for a user to select areas were more practice with the questions is desired. It also provides a confidence level for a user indicating areas and topics where they have performed satisfactorily. Reports may be periodically transmitted to a user and may be based on standard reporting results or on user's preferences for receiving result reports. Reports may be generated for specific time periods, for example, “last week's results” or in composite for greater lengths of time. Reports are also be generated by subject.

Standard database reporting tools may be used to effectuate the reporting function described herein by using results data alone or in combination with customer data. The reporting function also allows comparison between differing users to indicate how a user or groups of users perform. Using the law school example of FIG. 3, students could compete against each other and the reports would indicate performance. Also groups could compete against groups so that different schools or classes could compete against each other.

One aspect of the instruction system would allow for custom questions to be presented to a predetermined group of users. For example a contract law professor could add her own set of questions, or select from pre-existing questions. The professor could set a time limit for questions to be answered in a given period. The questions would be presented over the set time interval to the users and the results tracked. Results from the users would be shared with the users and the professor. The professor could provide notes on specific questions that would be available to the users in response to parameters set by the professor.

Another aspect provides for hints to be provided to a user upon request. Each question may have a short hint that a user may see by selecting to see the hint. The hint is stored in one of the databases and transmitted to the client in response to a request to see the hint. Alternatively the hint may be transmitted with the question, and merely displayed upon request. Customization allows for different users to create hints for different questions or multiple hints may be provided for a question, but which hint to display would depend on parameters associated with a user.

Similarly configuration settings may be employed to select which users are provided which answers to a question in the event that multiple answers are available for a question. Configuration settings may also be employed to determine which users have access to which notes or discussion groups as well. Further, users can enter question information and present it to selected groups of users allowing the operation to be customized based on content and user.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method comprising:
selecting question information from a structured data source;
presenting a question to a user, said presentation occurring at predetermined time intervals;
measuring the length of time required for the user to respond to the question;
presenting the user additional question information, and
storing the user's response and the length of time required for the user to respond to the question in a structured data source.

2. The method of claim 1 further comprising:
transmitting the question information over a network, and
receiving the user's response and the length of time required for the user to respond to the question over a network.

3. The method of claim 1 wherein the predetermined time intervals are in response to a parameter set by a user.

4. The method of claim 1 wherein the predetermined time intervals are randomly generated.

5. The method of claim 1 further comprising:
storing user-generated information associated with a question for future presentation with the question.

6. The method of claim 1 further comprising:
presenting to the user a link to networked electronic discussion board associated with the question.

7. The method of claim 1 further comprising:
presenting to the user explanatory text associated with the question.

8. The method of claim 1 wherein the question information is selected in response to a predetermined set of users and presented to those users.

9. The method of claim 1 further comprising:
notifying the user that a question is available to present.

10. A system comprising:
a server having memory and a processor, coupled to a structured data source containing at least question information;
a client having a memory and a user interface, coupled to the server;
said server operative to provide question information to the client at a predetermined time, wherein the client notifies a user that a question is available;
said client operable to present the question to the user, measure the response time associated with the presentation and present additional question information to the user;
said client further operable to transmit to the server the user response and time, and
said server operable to reporting on user performance.

11. The system of claim 10 wherein the predetermined time is either in response to a parameter set by a user or random.

12. The system of claim 10 wherein the client is operable to collect user-generated information associated with the question, transmit the user-generated information to the server and present user-generated information associated with the question.

13. The system of claim 10 wherein the client presents to a user either a link to networked electronic discussion board associated with the question or explanatory text associated with the question.

14. One or more processor readable storage devices having processor readable code embodied on said processor readable storage devices, said processor readable code for programming one or more processors to perform a method comprising:
selecting question information from a structured data source;
presenting a question to a remote user, said presentation occurring at predetermined time intervals;
receiving a measurement of the length of time required for the user to respond to the question;
presenting to the remote user additional question information, and
storing the user's response and the length of time required for the user to respond to the question in a structured data source.

15. The device of claim 14 wherein the predetermined time intervals are either in response to a parameter set by a user or randomly generated.

16. The device of claim 14 wherein the method further comprises:
storing user-generated information associated with a question for future presentation with the question.

17. The device of claim 14 wherein the method further comprises:
presenting to the user a link to networked electronic discussion board associated with the question.
